(19) United States
(12) Patent Application Publication
(10) Pub. No.: US 2009/0307398 A1
(43) Pub. Date: Dec. 10, 2009

(54) Method for Manufacturing Memory Modules

(75) Inventors: Stefan Robl, Gerlingen (DE); Angelo Vicari, Gerlingen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta Gesellschaft fur Mess-und Regeltechnik mbH + Co KG, Gerlingen (DE)

(21) Appl. No.: 11/988,873

(22) PCT Filed: Jul. 13, 2006
(86) PCT No.: PCT/EP2006/064206

§ 371 Date: Mar. 23, 2009

(30) Foreign Application Priority Data
Jul. 20, 2005 (DE) 10200534494.1

(51) Int. Cl. G06F 13/14; G06F 13/00; G06F 12/00

(52) U.S. Cl. 710/104; 710/305; 711/103; 711/E12.001

(57) ABSTRACT

In a method for manufacturing memory modules MM, first a support board SB is populated with memory components MC. After the populating process, individual memory components MC are programmed via a bus system BS provided on the support board. After programming, the support board SB is separated into individual memory modules MM.

The invention relates to a method for manufacturing memory modules, as well as a support board for performing the method of the invention.

Often used in process automation technology are measurement transmitters equipped with memory modules for storing parametering data, log books, etc. Such memory modules are composed, as a rule, of flash memory components, which are arranged together with other components on circuit boards. The storage capacity of the memory components is relatively large, for instance, in given circumstances, even more than 16 MB.

In the manufacture of a measurement transmitter, especially in the populating of the electronic modules, these memory components must be programmed. Due to the high storage capacity, the programming is very time consuming. The programming time (about 1-5 minutes) for a memory component is considerably higher than the populating time for other components. This means a considerable delay in populating the circuit boards due to the required programming of the memory components. Such delays are very disadvantageous, especially in the case of expensive and fast automatic populating machines used in the assembly of electronic modules. The automatic populating machine must wait until the memory component concerned has been programmed. Only thereafter can the circuit board be populated with the memory component and other components.

Currently, memory components are programmed using special programming devices (e.g. Roadrunner of the firm, Data IO) before the actual populating of the boards. It is possible to program four memory components in parallel with such a system and then feed them to the intake point of an automatic populating machine. The always-growing storage capacity of memory components will certainly lead to further delays due to the programming step. In spite of the parallel programming known today for four memory components, there are still delays involved in the assembly of the electronic modules.

A possibility for avoiding such delays rests, in principle, on using memory components that have already been programmed by the manufacturer. In such cases, however, last-minute changes of the data can no longer be taken into consideration. Due to the frequency of change of the data to be written, this option is really not practical. It would lead to considerable added cost, since entire runs of memory components would become unusable, and would have to be sent back to the manufacturer. Also, in the case of important changes, the time delay would not be acceptable.

A further disadvantage of the above-named method is that the memory components are programmed before the circuit boards are populated, and can be only preliminarily checked at that time. The perfect functioning of the complete memory modules can first be tested only after the soldering process, which follows the populating of the circuit boards. Errors that can occur in the soldering process must then be corrected in an additional process step.

An object of the invention is to provide a simple method for manufacturing memory modules, which method is effective, fast, and reliable, and which is suitable for rapid production processes. This object is achieved through the process features as defined in claim 1.

Method for manufacturing memory modules, characterized by the following process steps:
a. Populating a support board, which is subdivided into a plurality of segments, with memory components, wherein each memory module is composed of one segment having one memory component; and
b. programming individual memory components via a bus system provided on the support board.

Advantageous further developments of the invention are described in the dependent claims.

An essential idea of the invention is that the memory components are no longer programmed during the populating process; rather, a support board is populated with a plurality of memory components, and the memory components are programmed only after the separate support board has been populated. Finally, the support board is separated into individual memory modules with pre-programmed memory components. These memory components can be applied quickly and simply in a further production step at the completion of the electronics module, and/or at the final assembly of the measurement transmitter.

Used for programming the individual memory modules of the support board is a bus system provided on the support board. The bus system enables operation of all memory components placed thereon.

For programming the individual memory modules, the bus system advantageously includes an address bus, a data bus, and a control bus.

In addition, the bus system also has an address decoder.

In a further development of the invention, the memory components are so-called flash memories (flash-memory components).

In a further development of the invention, the memory modules are punched or sawed out of the support board before they are used.

The support board required for implementing the method of the invention has a bus system, which connects the individual segments of the board.

The invention will now be described in further detail on the basis of an example of an embodiment illustrated in the drawing, the FIGURE of which shows as follows:

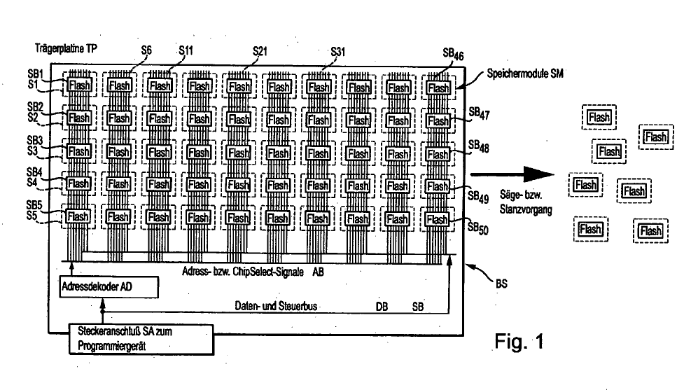

FIG. 1 support board of the invention, with a plurality of memory modules.

FIG. 1 shows a support board SB with a plurality of memory modules MM (a total of 50), following populating and soldering of the board. Each memory module MMᵢ, i=1-50, belongs to a specific segment Sᵢ, i=1-50, on the support board SB. For clarity, neither all 50 memory modules nor all 50 segments are numbered.

The individual segments Sᵢ are connected with one another via a bus system BS. The bus system BS includes an address bus AB, a data bus DB, as well as a control bus CB. Furthermore, the bus system BS includes an address decoder AD, which is connected with the address bus AB. The address decoder enables selection according to the system “1-of-n”—in this way, a large number of bus participants (in this case memory modules) can be operated with only a small number of address signals.

A plug connector PK on the support board SB serves for connecting with a programming device.

For clarity, additional components arranged on the memory modules, such as e.g. ESD protection circuits, are not drawn.

Segmented support boards of this type are frequently referred to as panels.

The method of the invention will now be described in greater detail. The support board SB is populated, in conventional manner, with memory components MC. The memory components are programmed only after the soldering process. For this, an appropriate programming device is connected with the support board via the plug connector PK. Then, data is written into the individual memory components MC. This procedure is referred to as programming.

Via the bus system BS provided on the support board SB, data can be transferred to individual memory modules MM. If problems occur during the programming of individual memory components MC, these memory components are recognized as defective. Error recognition is carried out by the programming algorithm required anyway for the memory components MC. Before populating the electronics components of a measuring transmitter, the individual memory modules MM are punched or sawed out of the support board SB. Then, they can be individually fed to an automatic populating machine.

An essential advantage of the method is that the programming process responsible for delays during populating can be shifted to a later, non-critical point in time. The automatic populating machines used in production can, in this way, be utilized optimally. Instead of waiting for a memory component to be programmed, additional or other boards can be populated. Delays as a result of the programming process no longer occur during mounting of a memory component; in this way, throughput is maximized, and total production costs are lowered.

Additionally, through the separation in time between the populating process and programming, it is possible to produce a “stockpile” of memory modules. The data required for the completion of a product can be programmed immediately prior to assembly.

For carrying out the method of the invention, a support board SB is necessary, on which an appropriate bus system BS is provided. Such a bus system BS can be integrated relatively cost-effectively into the support board SB at the time of production of the support board.

After the support board SB is separated into the individual memory modules MM, the bus system is unusable. The part of the support board with the address decoder AD and the plug connector PK is disposed of as electronic waste.

A further advantage offered by the method of the invention is that a plurality of support boards SB can be connected to one programming device at the same time, thus multiplying the number of memory modules MM which can be simultaneously programmed.

1-8. (canceled)

9. A method for manufacturing memory modules, comprising the steps of:
populating a support board, which is subdivided into a plurality of segments, with memory components, wherein each memory module is composed of one segment having one memory component; and
programming individual memory components via a bus system provided on the support board.

10. The method as claimed in claim 9, wherein:
the bus system comprises an address bus, a data bus, and a control bus.

11. The method as claimed in claim 10, wherein:
the bus system includes an address decoder.

12. The method as claimed in claim 9, wherein:
the memory components are flash memories.

13. The method as claimed in claim 9, further comprising the step of:
separating the support board into individual memory models after programming of the memory components.

14. The method as claimed in claim 13, wherein:
the memory modules are punched or sawed from the support board.

15. An apparatus for carrying out the method described in claim 9.

16. A support board, subdivided into a plurality of segments, each receiving memory components that are connected with one another via a data bus.
